(19) United States
(12) Patent Application Publication
(10) Pub. No.: US 2008/0040244 A1
(43) Pub. Date: Feb. 14, 2008

(54) Tracking and Managing Assets

(75) Inventors: Paul J. Ricciuti, Davenport, IA (US); Mark R. Ziegler, Bettendorf, IA (US)

Correspondence Address: FISH & RICHARDSON PC, P.O. BOX 1022, MINNEAPOLIS, MN, 55440-1022, US

(73) Assignee: LOGCON SPEC OPS, INC., Davenport, IA (US)

(21) Appl. No.: 11/772,526

(22) Filed: Jul. 2, 2007

Related U.S. Application Data
(60) Provisional application No. 60/836,169, filed on Aug. 8, 2006.

(51) Int. Cl. H04B 7/00; G06Q 10/00

(52) U.S. Cl. 705/28; 340/10.1

(57) ABSTRACT

A system and method including a local network formed of a plurality of identification devices that are operable to initiate communication with other identification devices to form the local network and are further operable to poll other identification devices, each identification device in wireless communication with at least one other identification device such that each identification device is capable of direct or indirect communication with other identification devices in the network. A gateway in wireless communication with the local network can allow direct or indirect communication between the gateway and each identification device in the local network. A central shipment controller can be configured to communicate with the gateway and is operable to receive data from and transmit data to the local network via the gateway. Each identification device can include a local device controller operable to switch the identification device between device operating states.

### CROSS REFERENCE TO RELATED APPLICATIONS

This application claims the benefit of U.S. Provisional Patent Application No. 60/836,169, filed Aug. 8, 2006, which is incorporated herein by reference in its entirety.

### TECHNICAL FIELD

This invention relates to asset tracking, and more particularly to identification devices and the use of identification devices to track and manage assets through a supply chain and/or conduct automated transactions.

### BACKGROUND

Identification devices, for example identification devices commonly known as ‘tags’, used in supply chain management include radio frequency identification (RFID) devices. Passive RFID devices have no internal power supply. An incoming radio frequency signal induces a small electrical current in an antenna in the RFID device thus providing enough power for an integrated circuit (IC) in the device to power up and transmit a response. Unlike passive RFID devices, active RFID devices have their own internal power source which is used to power any ICs that generate the outgoing signal. Active devices are typically more reliable than passive devices due to the ability for active devices to conduct a “session” with a reader. Active devices, due to their onboard power supply, also can transmit at lower power levels than passive reading devices.

### SUMMARY

Novel asset tracking and logistics systems enable real time or near real-time visibility of assets including inventory and surveillance of assets both in transit and in storage. Asset tracking and logistics systems may enable automation of supply chain management processes such as inventory, receipt, issue, storage, and transportation of assets.

In one aspect, munitions transactions systems include: a local network formed of a plurality of identification devices, each identification device associated with an asset, the identification devices operable to initiate communication with other identification devices to form the local network and are further operable to poll other identification devices to determine which identification devices are present in the network, each identification device in wireless communication with at least one other identification device such that each identification device is capable of direct or indirect communication with other identification devices in the network; a gateway in wireless communication with the local network via at least one of the plurality of identification devices to allow direct or indirect communication between the gateway and each identification device in the local network; a central shipment controller configured to communicate with the gateway, the central shipment controller operable to receive data from and transmit data to the local network via the gateway; and a secondary shipment controller configured to communicate with the local network and to communicate with the central shipment controller, the secondary shipment controller operable to generate and transmit a receipt to the central shipment controller upon arrival of one of the assets at a destination; wherein each identification device having a plurality of operating states, each identification device including a local device controller operable to switch the identification device between device operating states.

In another aspect, asset tracking systems for tracking inventory include: a local network formed of a plurality of identification devices, each identification device associated with an asset, the identification devices operable to initiate communication with other identification devices to form the local network and are further operable to poll other identification devices to determine which identification devices are present in the network, each identification device in wireless communication with at least one other identification device such that each identification device is capable of direct or indirect communication with other identification devices in the network; a gateway in wireless communication with the local network via at least one of the plurality of identification devices to allow direct or indirect communication between the gateway and each identification device in the local network; and a central shipment controller configured to communicate with the gateway, the central shipment controller operable to receive data from and transmit data to the local network via the gateway; wherein each identification device has a plurality of operating states, each identification device including a local device controller operable to switch the identification device between device operating states.

In another aspect, munitions transfer methods include: self forming a first local network from a plurality of identification devices, each identification device associated with an asset, the identification devices operable to initiate communication with other identification devices to form the local network and are further operable to poll other identification devices to determine which identification devices are present in the network, each identification device in wireless communication with at least one other identification device such that each identification device is capable of direct or indirect communication with other identification devices in the network; communicating the availability of assets associated with the plurality of identification devices forming the local network to a central shipment controller via a gateway in communication with the local network; using the central shipment controller to generate a shipment order in response to an ammunition request, the shipment order including a destination codes and a priority codes for ordered assets associated with a first subset of devices of the plurality of identification devices; communicating the destination codes and the priority codes from the central shipment controller to the first subset of devices; and using a secondary shipment controller to generate a receipt upon arrival of the ordered assets.

Embodiments of the systems and methods can include one or more of the following features.

In some embodiments, each identification device is operable to receive data from another portion of the network (e.g., a central computer, gateway, or another identification device) using two way communication. For example, a barcode may be scanned (e.g., by a worker using a handheld device) and information from the barcode may be written to the identification device.

In some embodiments, each identification device receives data exclusively from another portion of the network (e.g., from a handheld device).

In some embodiments, each identification device receives data from another portion of the network (e.g., a central computer, gateway, or another identification device) and subsequently communicates with a peer-to-peer network to receive additional data resident in an accountable system.

In some embodiments, each identification device includes the data, such as destination code and a priority code and other data, required to facilitate legal transactions from consignor to consignee. In some cases, the destination code and the priority are generated by the central shipment controller.

In some embodiments, each identification device includes a status code. The status code can include a transit status flag, an environmental condition flag, a movement flag, and/or a power status flag. In some cases, the local device controller is operable to generate the status code. In some cases, the local device controller is operable to switch the identification device between device operating states having different network polling rates based at least in part on the status code.

In some embodiments, wherein the local network includes an environmental condition sensor and the identification devices are operable to store environmental condition data. For example, some environmental condition sensors sense at least one of temperature, vibration, humidity, chemicals, and gases.

In some embodiments, electronic emissions of the identification devices in the network are within the limitations imposed by Hazards of Electromagnetic Radiation to Ordnance (HERO) certification requirements (e.g., have an average isotropic-equivalent effective radiated power of 25 mW or less and frequencies of 100 MHZ or greater for a standoff of 0 feet or next to touching).

In some embodiments, systems also include a global positioning system unit in communication with the gateway.

In some embodiments, the gateway is a mobile gateway with a first communication unit and a satellite communication unit with the mobile gateway configured to communicate with the central shipment controller using the first communication unit when infrastructure for the first communication unit is available and to communicate with the central shipment controller using the satellite communication unit when the infrastructure for the first communication unit is not available. In some cases, the first communication unit includes is a cellular communication unit. In some cases, the first communication unit is configured to connect to the Internet.

In some embodiments, methods also include using one of the central shipment controller or the secondary shipment controller to revise one of the destination codes in response to receipt of a higher priority ammunition request.

In some embodiments, methods also include setting a device status code and storing the device status code in memory included in an associated identification device, the status code including at least one of a transit status flag, an environmental condition flag, and a power status flag. In some cases, methods also include switching the identification device between device operating states having different network polling rates based at least in part on the status code.

In some embodiments, methods also include monitoring an environmental condition sensor included on one of the identification devices. In some cases, the environmental condition sensor senses at least one of temperature, vibration, humidity, chemical, and gases.

In some embodiments, methods also include determining a location of the identification devices using a global positioning system unit.

In some embodiments, methods also include establishing communications between the gateway and one of the central and secondary shipment controllers using a first communication unit when infrastructure for the first communication unit is available and using a satellite communication unit when the infrastructure for the first communication unit is not available.

In some embodiments, methods also include using a parent identification device to conduct a local network poll to determine which identification devices are present in the network. In some cases, methods also include using the parent identification device to reform the local network if the identification devices present changed from a previous network poll and/or communicating to the gateway a listing of identification devices present at the previous network poll that did not respond to the current network poll.

Munitions/asset transactions systems as described herein can provide significant advantages including reduced manual procedures, straightforward implementation, and robust operation. Munitions/asset transactions systems that include self-forming and self-healing networks of identification devices may provide real-time inventory and complete visibility throughout the supply chain with little or no intervention by workers. Thus, for example, such munitions/asset transactions systems may improve the security of the supply chain by immediately detecting lost or stolen assets. Munitions/asset transactions systems may also be used to implement issuance and receipt procedures to further enhance secure and safe handling of munitions/assets traveling through the supply chain.

The transactions systems as described herein include identification devices that can initiate communication with other identification devices or a gateway to self-form and self-heal into ad hoc peer-to-peer communication networks. By making use of short communication paths, self-forming and self-healing networks can use low power and can emit low levels of electromagnetic radiation. Accordingly, munitions transactions systems described herein can be reliable and safe for use in close proximity to munitions.

In another aspect, identification tags include: a power supply; wireless communications circuitry powered by the power supply; and a controller powered by the power supply, the controller configured to operate the communications circuitry to communicate with a second identification tag and further configured to switch the identification tag from a first operating state to a second operating state.

Embodiments of the systems and methods can include one or more of the following features.

In some embodiments, the controller is configured to operate the communications circuitry to receive data specific to a plurality of other identification tags, to generate a combined data signal by incorporating data specific to the identification tag with the data specific to the plurality of other identification tags, and to transmit the combined data signal.

In some embodiments, identification tags also include memory circuitry, the controller configured to perform read/write operations on the memory circuitry. In some cases, identification tags also include sensors (e.g., an environmental sensor or sensors sensing temperature, vibration, humidity, chemicals, and/or gases). In some cases, the controller is configured to store readings of the environmental sensor on the memory circuitry. In some cases, the controller is configured to generate a status code based on readings of the environmental sensor.

In some embodiments, the controller is configured to check for the presence of a network of linked identification tags upon activation of the identification tag. In some cases, the controller is configured to generate a request to join a detected network of identification tags. In some cases, the controller is configured to operate the communications circuitry to transmit information received from the second identification tag. In some cases, the controller is configured to select a third identification tag to transmit the information received from the second identification tag. For example, the controller can be configured to select the third identification tag based at least in part on a low power signal transmitted by another identification tag.

In some embodiments, the controller is configured to operate the communications circuitry to transmit information received from the second identification device.

In some embodiments, the controller is configured to maintain a status code. In some cases, the controller is configured to generate the status code. In some cases, the first operating state has a first network polling rate and the second operating state has a second network polling rate and the controller is configured to switch the identification tag between the first operating state and the second operating state based at least in part on the status code.

In some embodiments, the controller is configured to operate the wireless communications circuitry when the identification tag is in the first operating state and an alternate communications device when the identification tag is in the second operating state.

In some embodiments, the identification tag is configured to use less power in the first operating state than in the second operating state. In some cases, the controller is configured to switch the identification tag from the first operating state to the second operating state in response to a signal from a movement detector.

In some embodiments, the controller is configured to generate a request to join a detected network of identification tags when the identification tag is in the first operating state. In some cases, the controller is configured to form a new network when the identification tag is in the second operating state.

The transaction systems and methods and identification devices and tags as described herein can also be used to improve accuracy of munitions/asset transfers and/or as part of theft prevention processes. For example, while stored, the identification device may be placed in a sleep mode (to conserve power) with a movement flag set indicating that movement is not expected. Upon a transaction issuing the associated munitions/assets, the movement flag can be cleared (e.g., indicating that movement of the identification device and associated munitions/assets is allowed). In some embodiments, if the movement flag is set indicating that movement is not expected and sensors on the identification device note movement of the identification device above pre-set thresholds, an alert can be triggered. The alert can involve awakening of the identification device and transmission of data indicating that unexpected movement has been detected. Unexpected movement can indicate that storage facility personnel have selected the wrong munitions/assets to fill an order or that unauthorized movement or tampering with the munitions/assets is occurring. In addition, the timing of munitions/asset transactions and subsequent movement of munitions/assets can be automatically tracked as an input for business process improvements.

The transaction systems and methods and identification devices and tags as described herein can also be used to provide real time inventory of assets in custody (e.g., munitions in a storage depot) and/or in transit. Self-formed networks of identification devices (e.g., identification tags) can act as virtual databases of assets. The networks can be polled to identify assets which are present. Local and/or central controllers can be configured to report, for example, which assets are currently present as well as changes in inventory (e.g., assets that have been added or deleted since the last network poll or changes in asset status). The visibility in asset inventory and asset status can help logistics personnel in management of storage, transport, and transfer of assets.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates a system for tracking assets through a supply chain.

FIG. 2 illustrates a portion of the system of FIG. 1.

FIG. 3 is a flowchart diagram of the operation of identification devices to create a peer-to-peer network.

FIG. 4 is a flowchart diagram of the operation of the peer-to-peer network of FIG. 3.

FIG. 5 is a flowchart diagram of the operation of the system of FIG. 1 to ship assets.

FIG. 6 is a flowchart diagram of the operation of the system of FIG. 1 to receive assets.

Like reference symbols in the various drawings indicate like elements.

### DETAILED DESCRIPTION

Systems and methods of tracking and managing assets (e.g., munitions, personnel protective equipment such as chemical/biological protective gear, or medical supplies) using identification devices to establish self-forming, self-healing networks can reduce the amount of labor and infrastructure required to track the assets through a supply chain (e.g., in transit and/or in storage). The self-forming, self-healing networks established by the identification devices can be in communication with gateways which link local device networks to remote units or networks to provide enhanced visibility of the assets in the supply chain. Individual identification devices store information including, for example, ammunition status, to improve the efficiency, security, and speed of the supply process. Assets to which identification devices are attached can be aggregate assets such as, for example, pallets of small arms ammunition with a single identification device is attached to each pallet and/or individual assets such as, for example, individual missiles with an identification device attached to each missile.

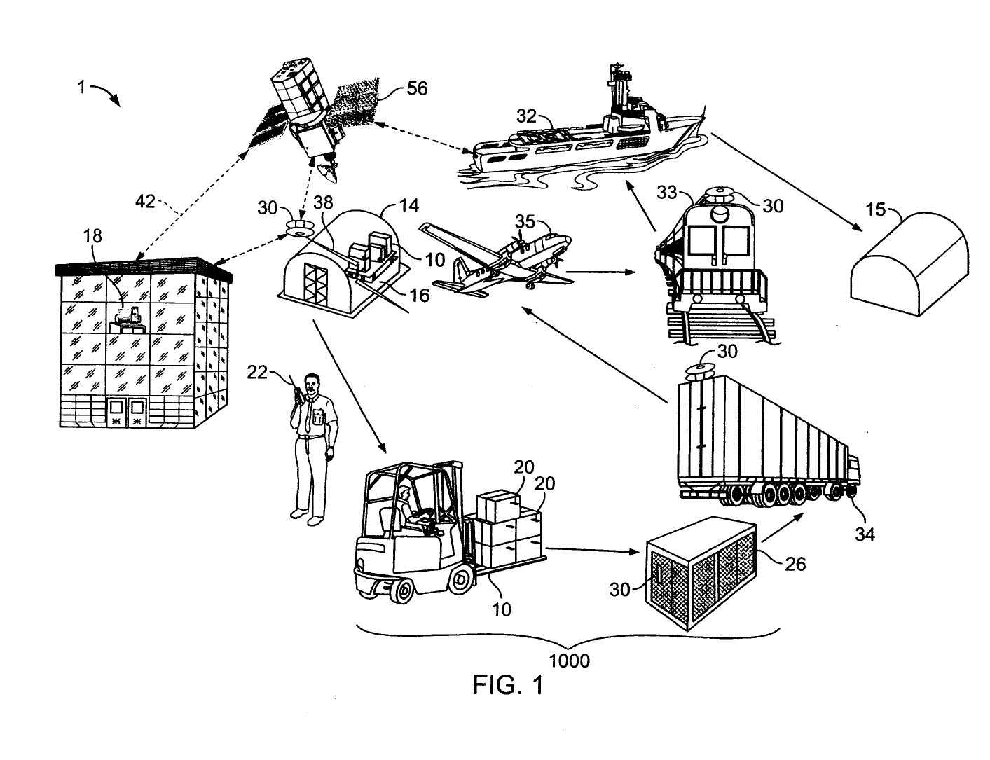

Referring to FIG. 1, a logistics system 1 monitors the removal and addition of assets 10 stored in a storage facility 14 as well as the location of assets 10 along supply chain 1000. Logistics system 1 includes identification devices 20 in a self-formed network. In the illustrated embodiment, identification devices 20 are in wireless communication with one or more gateways 30. Logistics system 1 may include a central controller 18 (e.g., a central computer) in wireless communication with gateways 30. Logistics system 1 may also include one or more handheld devices 22 to facilitate communication between components of logistics system 1. For example, as explained below, handheld devices 22 may be in wireless communication with gateways 30 and identification devices 20 to check that appropriate assets 10 are shipped. As another example, handheld devices 22 may interrogate identification devices 20 to verify the identity of assets 10 before the assets are received from or issued to the storage facility 14.

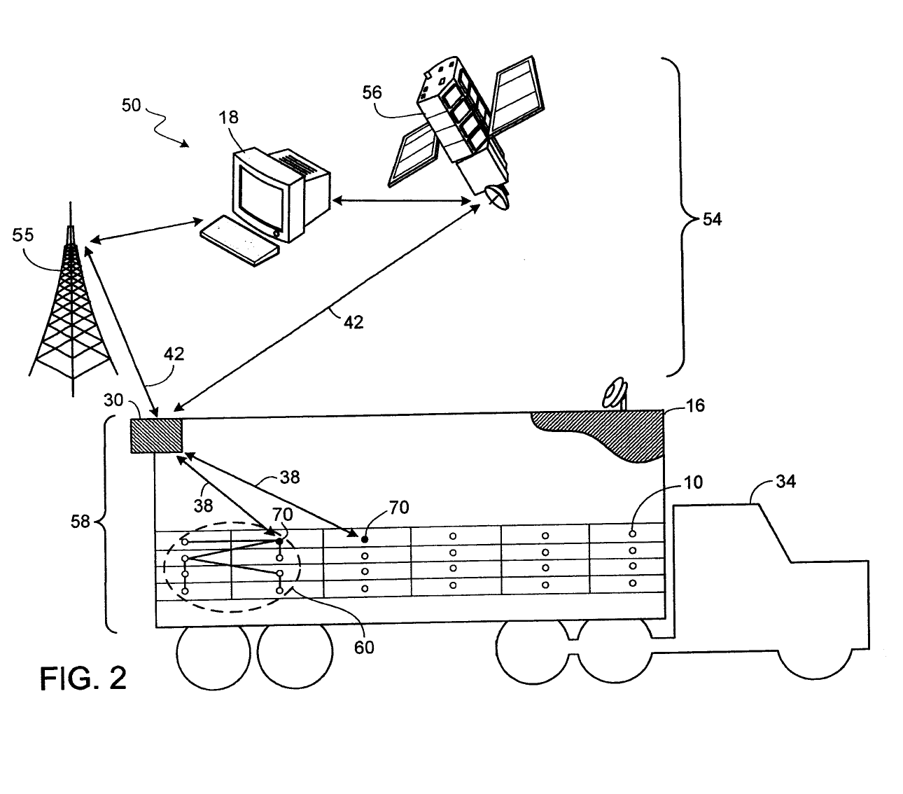

Referring to FIGS. 1 and 2, identification devices 20 and gateways 30 form an ad hoc peer-to-peer network 50, wherein the nodes of the network may include identification devices 20, gateways 30, central computer 18, and handheld devices 22. Peer-to-peer network 50 may be formed using components (e.g., identification devices 20 and gateways 30) that communicate using an industry standard protocol (e.g., IEEE Std. 802.15.4-2003 or ZigBee™). Some handheld devices 22, gateways 30, and/or additional components (e.g., in-theatre logistics computers) can be configured to act as a secondary shipment controllers to provide backup to central computer 18 and to provide secondary control of assets and shipments in a local area (e.g., a depot, a port, etc).

It should be understood that the nodes of the network may be arranged in any of a number of embodiments. In some embodiments, communication through the nodes of the network may be routed to minimize the overall power demand on peer-to-peer network 50. In other embodiments, communication through the nodes of the network may be routed to minimize the power demand from identification devices 20. For example, communication through the nodes of the network may be rerouted in response to a low power signal from one or more identification devices 20. As will be discussed in further detail below, the routing of communication through the nodes of peer-to-peer network 50 may change as assets 10 are moved within supply chain 1000 (e.g., moved from storage facility 14 to truck 34) or as assets 10 are added to or removed from (e.g., stolen or misplaced) the supply chain.

Gateways 30 may be positioned through supply chain 1000 to provide central computer 18 with increased visibility of assets 10 flowing through supply chain 1000. In the illustrated system, gateways 30 are mounted on the walls of storage facility 14 as well as on trucks 34 or shipping containers 26. Gateways 30 can be mounted on trucks 34 and/or shipping containers 26 such that a portion of gateway 30 is exposed to ambient environment, thereby facilitating communication with central computer 18.

Gateways 30 and central computer 18 may form a top layer 54 of peer-to-peer network 50 by communicating using higher power communication 42. The exemplary network includes communications in top layer 54 over a cellular phone network 55 and over a satellite network 56. The term “satellite network” is used to indicate one or more networks at least partially based on transmissions to and/or from satellites. For example, gateways 30 may communicate with both a satellite based communications network and a separate satellite based global positioning system (GPS) network. Communications in top layer 54 may occur over a satellite network 56 that includes an existing satellite communication link in supply chain 1000 (e.g., the satellite communication link aboard truck 34 carrying assets 10). Gateways 30 may communicate with satellite network 56 to receive positioning information (e.g., from a GPS). Thus, for example, gateways 30 may receive positioning information from satellite network 56 and append this positioning information to outgoing communication (e.g., communication with central computer 18, other gateways, or with identification devices 20).

In some embodiments, communication in top layer 54 may switch between communicating over satellite network 56 and cellular phone network 55. For example, a gateway 30 in top layer 54 may switch between satellite network 56 and cellular network 55 (e.g., using the cellular phone network when available and switching to the satellite network when the cellular phone network is not available) to limit the power consumed by the gateway. As another example, a gateway 30 in top layer 54 may switch between satellite network 56 and cellular network 55 to improve information security.

Identification devices 20 form one or more sub-layer 58 of peer-to-peer network 50 using lower power communications 38 to communicate with other identification devices, handheld devices 22, and gateways 30. For example, identification devices 20 stored in the trailer of truck 34 may use lower power communications 38 to communicate with a subset of identification devices also stored in the trailer of the truck, and at least one identification device may communicate with gateway 30 positioned on or in the trailer. Communication between identification devices 20 in peer-to-peer network 50 may be managed to minimize the power requirements of the identification devices. For example, identification devices 20 in peer-to-peer network 50 may communicate over short distances to conserve power. In some embodiments, peer-to-peer network 50 may be configured allow identification devices 20 to be certified under the HERO standard of the United States Department of Defense. In some embodiments, lower power communication level 38 may be limited to remain below a threshold value.

In some instances, identification devices 20 are operable to vary lower power communication level 38 depending on the devices' status in supply chain 1000. For example, an identification device 20 may switch from lower power communications 38 to higher power communications 42, thereby becoming part of top layer 54, if the identification device does not sense the presence of other identification devices or gateway 30. As another example, lower power communications 38 of identification devices 20 may be limited to one threshold value while aboard truck 34 and limited to another threshold value while in storage facility 14. As still another example, lower power communications 38 may be limited to a threshold value that varies inversely with the number of identification devices 20 in sublayer 58. Thus, in this example, the identification device communicates using a low power signal when it senses direct communication with a large number of nodes in peer-to-peer network 50 (e.g., when the identification device is stored on a pallet).

As shown in FIG. 2, sublayer 58 of peer-to-peer network 50 may include identification devices 20 arranged in clusters 60. Communication between identification devices 20 in each cluster 60 may occur directly for identification devices that are within broadcasting range of one another. Similarly, communication between at least one identification device 20 in each cluster 60 may occur directly with gateway 30 and handheld device 22. Likewise, communication between gateway 30 and central computer 18 may occur directly when central computer 18 is within broadcasting range of gateway 30. However, direct communication between each identification device in cluster 60 may not always be possible in peer-to-peer network 50. For example, the overall size of the cluster 60 may exceed the broadcasting range of each identification device 20. In these embodiments, identification devices 20 may also communicate indirectly, using direct communication between multiple intermediate identification devices to route messages between any two identification devices in cluster 60. As will be discussed in further detail below, communication through cluster 60 is dynamic to allow peer-to-peer network 50 to be self-healing as assets 10 are added to, moved within, and/or removed from local area 16. In some embodiments, this communication structure can enable formation of networks ranging in size from small local networks within a single shipping container to larger networks encompassing a large container field storing multiple shipping containers to still larger depot level networks encompassing multiple container fields and fixed storage structures such as magazines and/or warehouses.

Communication between elements of peer-to-peer network 50 (e.g., between identification devices 20 and central computer 18) may occur on a schedule. Communication between elements of peer-to-peer network 50 may also occur on demand, for example on an as-needed basis for inventory, environmental, or other necessary in-transit management functions (e.g., in response to trigger events).

Identifications devices 20 can include a local device controller incorporating logic (e.g., hardware and/or software) which controls device operation. Identification devices 20 can also include a memory that may be any of several sizes (e.g., 4 megabit, 128 kilobyte, and 4 kilobyte) and stores an identifier unique to each identification device. For example, the identifier may be a unique 64 bit extended address for identification device 20. As will be discussed in further detail below, the memory may further store data from the memory of other devices. For example, the memory may store the unique identifiers of neighboring devices. The memory may also store transaction data, asset data, and environmental data as required in a given application.

In some embodiments, identification devices 20 include a battery to allow the identification devices to perform communication and environmental monitoring functions. For example, the battery may be a lithium ion battery. The battery may be rechargeable, for example, while identification device 20 is attached to asset 10. Operation of identification devices 20 may be controlled to maximize the life of the battery included with the identification device. In some embodiments, identification devices 20 remain in a sleep mode (i.e., a low power consumption mode) between uses. For example, identification devices 20 in storage facility 14 may remain in a sleep mode between periodic (e.g., every six months) inventories of the storage facility. In some embodiments, movement of an asset can ‘awaken’ an attached identification device 20 from sleep mode.

Identification devices 20 may include one or more sensors that monitor one or more environmental conditions (e.g., temperature, shock, vibration, movement, and humidity) experienced by assets 10. Conditions sensed by the sensors may be monitored by logistics system 1 to ensure that assets 10 have not been damaged or otherwise compromised prior to use. Thus, logistics system 1 may be used to coordinate the supply of assets 10 that require careful handling prior to use (e.g., ammunition, medical supplies, and personnel protection devices such as chemical defense supplies). For example, logistics system 1 may prevent the shipment of medical supplies if identification devices 20 attached to those medical supplies detect excessive temperatures. In some embodiments, identification devices 20 include micro-electro-mechanical systems (MEMS) sensors.

Identification devices 20 may be operable to perform read/write operations such as writing or modifying data on a device. In addition, identification devices 20 may be customizable to perform read/write operations relevant to the assets 10 being tracked. For example, identification devices 20 may be operable to store information sensed by one or more sensors. In some embodiments, identification devices 20 store the entire history of information sensed by one or more sensors. In other embodiments, identification devices 20 store a portion of the history of information sensed by one or more sensors. For example, identification devices 20 may store information sensed over a fixed period of time (e.g., the previous minute or the previous 24 hours) such that information from previous fixed periods is continuously overwritten with newly measured information on a first-in, first-out basis. As another example, identification devices 20 may monitor an environmental condition but only store anomalous information (e.g., temperatures that exceed a threshold value).

In some embodiments, identification devices 20 are active radio frequency identification (RFID) devices. Identification devices 20 (e.g., identification tags incorporating communications circuitry) may communicate at a fixed frequency (e.g., 2.4 GHz, 433.92 MHz, or 915 MHz). In some embodiments, identification device 20 may be operable to vary its communication frequency. The modulation of the frequency may be AM, FM, Binary Phase Shift Keying, Direct Sequence Spread Spectrum, Frequency Hopping Spread Spectrum or another appropriate modulation scheme.

Gateways 30 may be designed to meet surrounding environmental requirements. In some embodiments, gateways 30 are configured to be compatible with the form of standard shipping containers 26 to allow tracked shipping containers to be handled in the same manner as untracked shipping containers. In other embodiments, gateways 30 may be shaped to be compatible with the door of the trailer of truck 34. In some embodiments, gateways 30 are hidden from view to prevent tampering and/or to avoid indicating the presence of valuable assets 10 that require tracking. For example, if truck 34 is carrying munitions in a hostile area, gateways 30 may be hidden from view to avoid alerting would-be hijackers to the value of assets 10 aboard the truck.

Gateways 30 may include a lower power communication level 38 and a higher power communication level 42. Gateways 30 may communicate with identification devices 20 using lower power communication level 38 to minimize the power consumed by gateways 30. In addition, gateways 30 may also communicate using lower power communication level 38 to minimize electromagnetic radiation in the vicinity of assets 10. For example, gateways 30 may use lower power communication level 38 to communicate with identification devices 20 when the identification devices are attached to munitions.

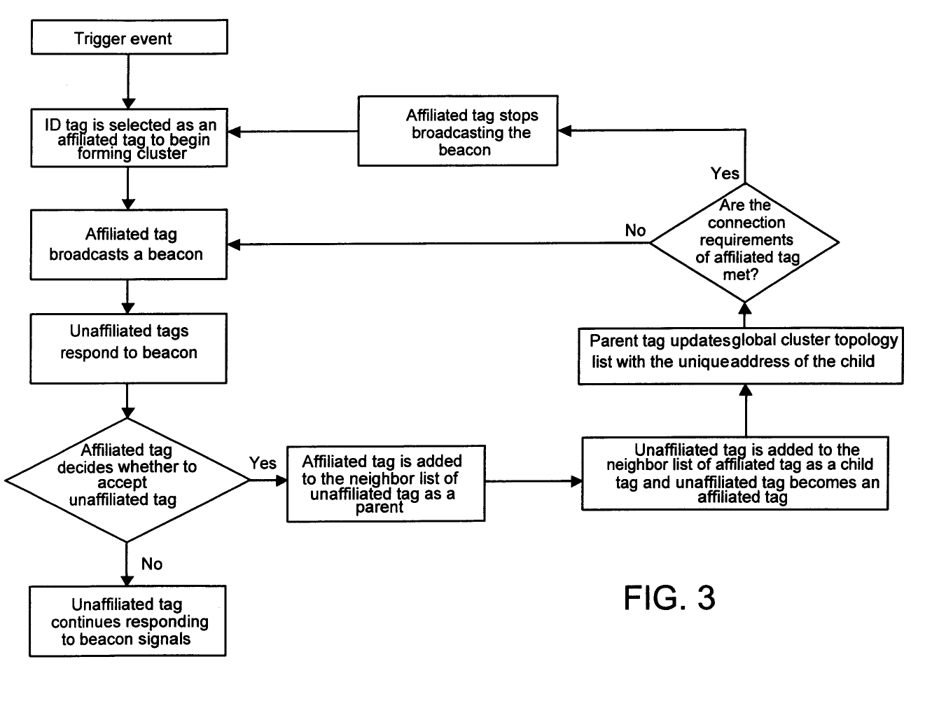

Referring to FIG. 3, the peer-to-peer network of identification devices is self-forming to minimize the time and human labor required to implement the tracking system. Assets attached to the identification devices may be initially placed in a local area without prior knowledge of the number or placement of other identification devices in the local area. The identification devices and gateways communicate using one or more common protocol to form the peer-to-peer network.

An existing peer-to-peer network may self-form (e.g., reform) upon the occurrence of a trigger event. In some embodiments, an existing peer-to-peer network may self-form after the passage of a given period of time (e.g., once a week). In some embodiments, a peer-to-peer network may self-form upon receiving a command from gateways and/or identification devices. For example, in these embodiments, a gateway may detect that a threshold fraction (e.g., 50 percent) of identification devices have been added to or removed from the local area and, therefore, command all or part of a peer-to-peer network to self-form.

Among identification devices in a local area, an identification device is selected as an affiliated device to begin forming a cluster (step 120). Before any network connections are formed (e.g., when assets are first put into a local area), the first affiliated device may be the first identification device to begin broadcasting a signal in the local area. After some network connections are formed in the local area, the first affiliated device may designate a child device to begin forming an adjacent cluster. For example, after a cluster has a maximum number of identification devices, the first affiliated device may designate the latest identification device to join the cluster to become the parent of a new cluster.

Once selected, the affiliated device broadcasts a beacon in the local area (step 130). The affiliated device may broadcast a beacon at random intervals to reduce any overlap with beacon signals broadcast by other identification devices in the local area. Reducing such overlap can reduce electromagnetic radiation in the local area, thereby facilitating HERO certification of the identification devices.

Next, unaffiliated devices respond to the beacon by requesting to join the cluster being formed by the affiliated device (step 140). Unaffiliated devices may respond to beacons at random intervals to minimize electromagnetic radiation in the local area. In some embodiments, the affiliated device may increase the power level of communication until it receives a desired number of responses from unaffiliated devices. In some embodiments, the affiliated device may change from a lower power level of communication to a higher power level of communication and become a gateway if its beacon receives too few responses from unaffiliated devices.

After receiving a response from an unaffiliated device, an affiliated device decides whether to accept the unaffiliated device into the cluster (step 150). The affiliated device may reject a request from an unaffiliated device if the signal from the unaffiliated child device is too weak. The affiliated device may reject an unaffiliated device if the parent device detects that the size of the cluster has exceeded a limit. In some embodiments, the limit of the size of the cluster may vary with the phase of the supply chain. For example, clusters may be larger where signal interference concerns are minimal (e.g., at a storage facility) and smaller where signal interference concerns are significant (e.g. in a storage container). If the original affiliated device rejects the unaffiliated device, the unaffiliated device searches for another affiliated device by responding to other beacons (step 160).

If the affiliated device adds an unaffiliated device to the cluster, the unaffiliated device begins transmitting a periodic beacon and other unaffiliated child devices may join the cluster through the same process (steps 120, 130, 140, 150). Thus, the topology of the identification devices that form the cluster may include multiple generations of identification devices (e.g., grandparents, parents, and children).

After an affiliated device adds an unaffiliated device to the cluster, the unaffiliated device amends its neighbor list to include the unique address of the affiliated device, and further designates the affiliated device as a parent (step 170). Likewise, affiliated device amends its neighbor list to include the unique address of the unaffiliated device, and further designates the unaffiliated device as a child (step 180). The parent device (i.e., the affiliated device) then communicates with all of the devices in the cluster to update a global cluster topology list (i.e., a list of the unique identifiers of each of the identification devices in the cluster (step 186). Consequently, as will be discussed in further detail below, the memory of each identification device in a cluster includes the global cluster topology list of the identification devices in the cluster. The global cluster topology list may include a listing of the unique identifiers of identification devices in the cluster (i.e., a listing of the identification devices that are in communication). The global cluster topology list may also include an indication of the parent/child relationships within the cluster to allow communication within the cluster to be preferentially routed through identification devices with a higher degree of connectivity (i.e., identification devices with the most child devices).

After the affiliated device adds the unaffiliated device to the cluster, the affiliated device determines whether its connection requirements are met (i.e., can the affiliated device add any additional child devices). If the connection requirements of the affiliated device are not met, it may continue broadcasting beacons to unaffiliated devices (194). If the connection requirements of the affiliated device are met, it may stop broadcasting a beacon signal (step 193) and it may select another identification device in the cluster to begin forming a new cluster (192).

Identification devices in a cluster may communicate with any other identification device in the cluster. For example, an identification device may communicate with another identification device along a direct communication path or an indirect communication path. Information about the preferred communication path of each identification device may be stored in the memory of each identification device. In some embodiments, communication through a cluster may begin after a parent device connects to a child device or a gateway. In other embodiments, communication through a cluster may begin after the composition of the cluster becomes stable. For example, communication through a cluster may begin after an affiliated device broadcasts a beacon a predetermined number of times without a response (i.e., no new unaffiliated devices are within range).

A gateway may also connect to the cluster by responding to the beacon of an affiliated device in the cluster as described above. Each gateway may be a member of more than one cluster such that each cluster is connected to at least one gateway. In some embodiments, a cluster may not include more than one gateway. In some embodiments, a gateway may connect to more than one identification device in a cluster to facilitate rapid and efficient (i.e., reduced consumption of overall power) communication through the cluster. Distributing the communication load between devices can also reduce the likelihood that an individual device will exhaust its available power.

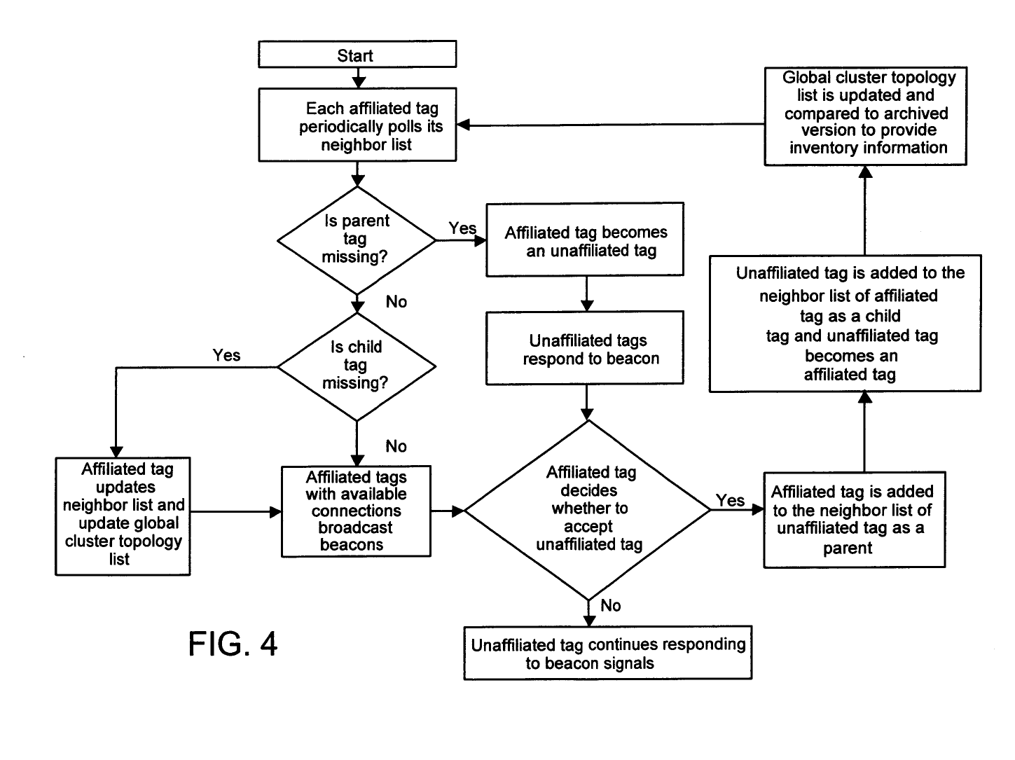

Referring to FIG. 4, a peer-to-peer network (e.g., peer-to-peer network 50) is self-healing to allow network communication to continue after the removal of assets from local area. As such, self-healing maximizes the robustness of a tracking system and provides real-time or near real-time automated inventory control by providing visibility of inventory throughout a supply chain. For example, the self-healing feature allows a peer-to-peer network to determine that assets have been taken from a local area. When assets arrive in another part of the supply chain, the tracking system may register the new position of the assets.

A peer-to-peer network may self-heal upon detection of a change in a global cluster topology list. As shown in FIG. 4, each identification device in a cluster periodically polls the other identification devices in its neighbor list (step 214). If a child device detects that its parent device is not responding to the polling (step 218), the child device detects that it is an unaffiliated device (step 234) and begins responding to beacons generated by affiliated devices (step 242). If an affiliated device decides to add the unaffiliated device (step 246), the affiliated device is added as a parent to the neighbor list of the unaffiliated device (step 254). Similarly, the unaffiliated device is added to the neighbor list of the affiliated device as a child device (i.e., the unaffiliated device becomes an affiliated device) (step 262).

Next, the parent device then communicates with all of the identification devices in the cluster to update the global cluster topology list (step 258). The process then repeats as parent device 70 and child device 74 each continue periodic polling of respective neighbor lists.

If parent device 70 detects that a child device in its neighbor list is not responding (step 222), the parent device updates its neighbor list and updates the global cluster topology list (step 226). The parent device may perform this process for each of the dependents of the dependent device.

Throughout the self-healing process, an affiliated device with available connections may broadcast a beacon (step 230). The process of beaconing from an affiliated device to an unaffiliated device may be the same as the process described above with respect to self-forming of the peer-to-peer network.

During self-formation or self healing of the peer-to-peer network, identification devices may send the global cluster topology list to gateway(s), other identification devices, or a central computer. In some embodiments, the gateway(s), identification devices, or central computer may communicate with one another to amass a master list of identification devices in the peer-to-peer network (i.e., all identification devices in all of the clusters that make up the peer-to-peer network). Additionally or alternatively, gateway(s) or identification devices may communicate with the central computer to amass a master list of identification devices in the peer-to-peer network. For example, each gateway may communicate a global cluster topology list to a central computer and, after amassing the various global cluster topology lists, the central computer may communicate the master list to each gateway. Communication between the central computer and the gateway(s) or identification devices may occur on demand, for example on an as-needed basis for inventory, environmental, or other necessary management and storage functions. Communication between the central computer and the gateway(s) or identification devices may also occur according to a schedule.

The master list of identification devices may be compared with archived versions of the master list of identification devices to determine the inventory of assets within the supply chain. For example, comparison of current and archived versions of the master list may provide the number and identity of assets missing from or added to a local area. As another example, comparison of current and archived versions of the master list may indicate which assets have been moved within local area 16 (i.e., assets that are missing from one global topology list but reappear in the peer-to-peer network in another global topology list).

In operation, the tracking system may automate many functions associated with inventory, shipping, and receiving of assets. In addition, by providing increased visibility throughout the supply chain, tracking system may reduce errors and other costs associated with supplying assets to customers.

For purposes of illustration, the operation of logistics system 1 is described as applied to the inventory, shipping, and receipt of ammunition. However, the tracking system may be used with other types of assets. For example, tracking system may be used with assets that require careful handling (e.g., medical supplies and chemical defense supplies). Different configurations and operational uses of the tracking system are appropriate for different applications. Accordingly, the methods of operation described below are illustrative in nature and will be modified to fit actual applications.

A peer-to-peer network of identification devices may be used to inventory ammunition stored in a local area. The inventory process may begin with a start command initiated in any of several ways. For example, the start command may be initiated by an internal clock function in each identification device. As another example, the start command may be initiated by a signal sent from a handheld device to a single identification device in the peer-to-peer network, wherein the signal is propagated through the peer-to-peer network to initiate the inventory process. As still another example, the start command may be initiated by initially placing identification devices in local area such that the inventory process occurs continuously.

Each identification device may receive condition information as part of the inventory process. For example, identification device may receive condition information from a handheld device. In some embodiments, condition information is entered into the handheld device after visual inspection of the asset attached to the identification device. In some embodiments, each identification device may receive condition information generated by a central computer and transmitted to the appropriate identification device through the peer-to-peer network. For example, a central computer may generate condition information indicating that a certain lot number of ammunition is defective. This condition information may be sent to gateway(s) and through the peer-to-peer network. For each identification device in the peer-to-peer network, the defective lot number may be compared to the lot number stored in the local memory of the identification device (i.e., the lot number of the asset associated with the identification device). If the defective lot number matches the lot number of the identification device, the defective condition may become associated with the identification device. Thus, when the identification device is being checked prior to issuance of an asset, the defective or potentially defective condition of the asset will be flagged.

In some embodiments, the identification device itself may generate condition information based on sensor readings of the identification device. For example, if a sensor on the identification device reads a temperature beyond a threshold value, the identification device may generate a condition flag to indicate that the asset has been exposed to an excessive temperature.

If a sensor reading exceeds a threshold value, the identification device may communicate this sensor reading or an alarm flag to another portion of the network (e.g., the central computer), thereby allowing a response capable of mitigating or preventing asset damage. The response may include an automated operation. For example, the response may include terminating communication in a portion of the network. The response may also include a manual operation by a worker. For example, a worker may respond by moving the asset.

In some embodiments, the identification device may receive condition information prior to the start of the inventory process (e.g., the identification device may receive condition information in between inventory periods if the inventory process is not continual).

In some embodiments, the tracking system may be used to execute a notice of ammunition reclassification (NAR) process. For example, a commodity manager may use a central computer to send out an NAR to change the condition information for corresponding identification devices in the storage facility. Workers at the storage facility may then respond to the NAR by using a handheld or remote wireless device to find reclassified identification devices and segregate or mark assets as required by the NAR.

As discussed above, identification devices in a local area may undergo the self-healing process to generate an inventory of identification devices in a local area. In addition to providing information on the identity of identification devices, the peer-to-peer network of identification devices may further communicate condition information of each identification device in the peer-to-peer network.

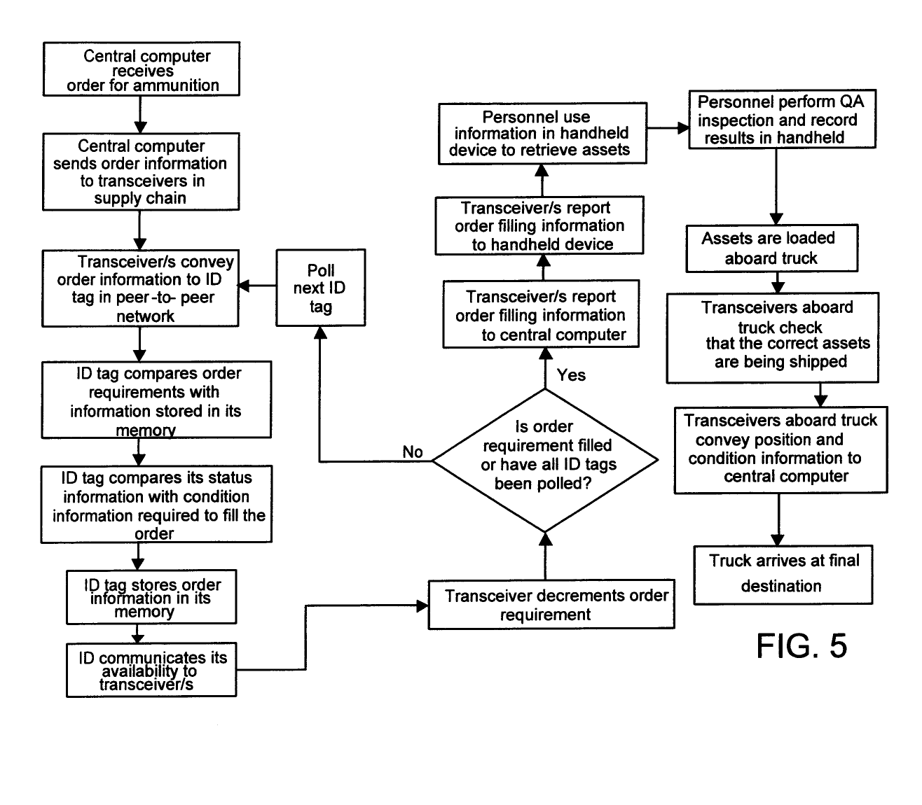

Referring to FIG. 5, a peer-to-peer network of identification devices may be used in issuing ammunition from a storage facility to a final destination. As shown in FIG. 5, a central computer may receive an order for ammunition (step 310). The central computer may communicate with multiple portions of the supply chain to facilitate the timely arrival of, for example, ammunition at a final destination. For example, upon receiving an urgent order for ammunition, a central computer may fill the urgent order by remotely communicating with the identification device and diverting ammunition that is en route to another destination to fill a less urgent order. For example, each identification device can have a destination code and a priority code. The destination code can provide information to allow personnel (e.g., in-theatre logistics personnel offloading a ship) to properly route assets (e.g., munitions) to units that have requested them. The priority code can provide information about the urgency of the request that the assets are being shipped to fill. If a higher priority request is entered into system 1, the central computer or a lower level controller can overwrite the destination code to reroute the asset associated with the identification device. The priority code would also be overwritten to reflect the priority of the new request. Logistics system 1 could then automatically generate a new order to replace the order being filled by the assets that were rerouted.

Upon receiving an order for ammunition, the central computer sends order information to gateways in the appropriate portion of the supply chain (e.g., gateways 30 located at storage facility 14) (step 314). The gateways then convey the order information through the peer-to-peer network to the identification devices. Each identification device may then compare the information stored in its memory to the order requirements (step 322). For example, each identification device may compare its ammunition type against the type of ammunition ordered. If the identification device corresponds to the appropriate ammunition type, the identification device may further compare its condition information with the condition information, if any, required to fulfill the order (step 326). If the identification device meets the criteria of the order, the identification device may store the order information in its memory (step 330) and communicate its availability to the gateway(s) (step 334). The gateway(s) may decrement the order requirement accordingly (step 342) and continue to search for available identification devices until the order is filled or until the order request passes through each identification device in the peer-to-peer network (step 346).

In some embodiments, identification devices or gateways in the storage area are associated with a section of the storage area (e.g., a grid or a bin), and data stored in the identification devices or gateways is updated as the order is filled. For example, an identification device may be associated with a bin containing ammunition, and data (e.g., quantity of boxes in the grid) stored on the identification device may be updated wirelessly to reflect fulfillment of the order.

After the order request passes through each identification device in the peer-to-peer network, gateway(s) may then report to the central computer the information of the identification devices (e.g., unique identifier and condition information) that will fulfill the order (step 350). In some embodiments, the gateway(s) may then report to the handheld devices the information of the identification devices that will fulfill the order (step 352). Using information stored on the handheld device, personnel may retrieve the assets associated with identification devices that will fill the order (step 354).

Requisitioned assets may be placed on a pallet. A new identification device may be commissioned and also placed on or attached to the pallet. Asset data may be wirelessly transferred to the new identification device. For example, an identification device associated with a grid or bin of the storage facility may transfer the assets' environmental history data to the new identification device on the pallet.

While stored, the identification device may be placed in a sleep mode (to conserve power) with a movement flag set indicating that movement is not expected. Upon a transaction issuing the associated munitions/assets, the movement flag can be cleared (e.g., indicating that movement of the identification device and associated munitions/assets is allowed). In some embodiments, if the movement flag is set indicating that movement is not expected and sensors on the identification device note movement of the identification device above pre-set thresholds, an alert can be triggered. The alert can involve awakening of the identification device and transmission of data indicating that unexpected movement has been detected. For example, unexpected movement can indicate that storage facility personnel have selected the wrong munitions/assets to fill an order or that unauthorized movement or tampering with the munitions/assets is occurring.

Personnel may perform quality assurance (QA) inspection of the assets associated with the identification devices (step 358). If the assets fail the QA inspection, personnel may note this information in handheld device and subsequently transmit this information to the identification device attached to the asset. The handheld device may subsequently place a replacement request with the gateway(s), thereby causing the gateway(s) to repeat the process of searching for identification devices. If the assets pass the QA inspection, personnel may store assets in a temporary holding area prior to shipment. Before the assets are loaded onto a truck, the handheld device may be used to recheck the identity of the identification devices.

Similarly, before the assets are allowed to leave the facility, gateways at the gate of the facility may recheck the identity of the identification devices. In some embodiments, the gateway is in communication with the gate of the facility and may prevent the gate from opening if the identity of the identification devices on the truck do not match the identity of the identification devices identified to fulfill the order. When assets are conveyed out of a local area network (e.g., when identification devices come into communication with gateways at the gate of the facility), identification devices may wirelessly transfer data to a centralized location (e.g., to central computer 18 for legal transfer of ownership out of the storage facility's accountable record.

Gateway(s) on the truck may again check the identity of the identification devices to ensure that the identification devices loaded onto truck in step 362 are identical to the identification devices that should be use to fulfill the order (step 366). Once the identification devices are loaded onto the truck, gateway(s) aboard the truck may convey position (e.g., information gathered through a GPS system) and status information to the central computer (step 370). At any point prior to receipt at the final destination, the central computer may reroute the identification devices and associated assets to coordinate the overall supply demands within the supply chain.

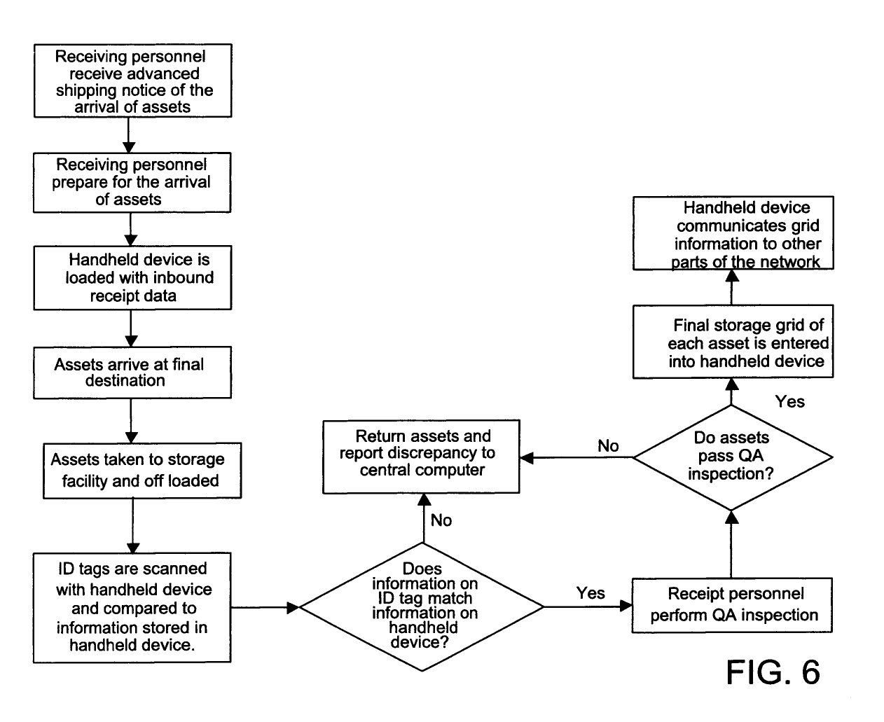

Referring to FIG. 6, a peer-to-peer network of identification devices may be used in receiving assets at a final destination. As shown in FIG. 6, receiving personnel at a final destination may receive advanced shipping notice of the arrival of assets (step 410). Advanced shipping notice may include the approximate arrival time of the assets and a detailed description of the assets that were shipped.

Next, receiving personnel may make necessary preparations for the arrival of the assets (step 414). For example, receiving personnel may generate an offload plan for handling sensitive ammunition. As another example, receiving personnel may allocate storage space for the assets.

Handheld device may be loaded with inbound receipt data (step 418). Inbound receipt data stored in a handheld device may include the unique identifiers and status information of the arriving assets. In some embodiments, the handheld device receives updated status information corresponding to the state of the assets in transit. For example, if an asset exceeds a threshold temperature while in transit, this information may be communicated to the handheld device such that receipt personnel may reject and/or segregate the asset upon arrival at the final destination.

After the assets arrive at the final destination, the assets may be taken to the storage facility and off loaded (step 454). The identification devices attached to the assets may be scanned with a handheld device and compared to the information stored in the handheld device (step 430). If assets do not match the information stored in handheld device, receipt personnel may return the assets and report the discrepancy to the central computer (step 434).

If the assets match the information stored in the handheld device, receipt personnel may perform QA inspection on the assets (step 442). Receipt personnel may then document the inspection results in handheld device. In some embodiments, the identification devices automatically and wirelessly transfer required data to the final destination's peer-to-peer network to allow legal transfer of ownership of the asset to the final destination's accountable record.

The assets may then be placed in location and the final storage grid of each asset may be entered into the handheld device (step 458) to facilitate retrieval of the assets in the future. To ensure that grid information is not lost (e.g., as a result of failure of the handheld device), the handheld device may communicate the grid information of the assets to other parts of the network (e.g., gateway(s) 30 or central computer 18) (step 462). Data stored on identification devices entering the storage facility may be wirelessly transferred other identification devices or gateways in the storage area.

A number of embodiments of the invention have been described. Nevertheless, it will be understood that various modifications may be made without departing from the spirit and scope of the invention.

In one example, some ships used for transporting munitions are configured with internet connectivity. Accordingly, gateways and/or identification devices can be configured to communicate with the central controller/computer through the internet when secure internet access is available.

In another example, communications can be implemented over various systems including, for example, wireless personal area networks, wireless local area networks, and wireless metropolitan area networks.

In another example, identification devices can be placed on storage facility equipment including, for example, trucks, forklifts, and other handling equipment. These identification devices can be used for applications such as tracking the location of the storage facility equipment,

Accordingly, other embodiments are within the scope of the following claims.

What is claimed is:

1. A munitions transactions system comprising:
a local network formed of a plurality of identification devices, each identification device associated with an asset, the identification devices operable to initiate communication with other identification devices to form the local network and are further operable to poll other identification devices to determine which identification devices are present in the network, each identification device in wireless communication with at least one other identification device such that each identification device is capable of direct or indirect communication with other identification devices in the network;
a gateway in wireless communication with the local network via at least one of the plurality of identification devices to allow direct or indirect communication between the gateway and each identification device in the local network;
a central shipment controller configured to communicate with the gateway, the central shipment controller operable to receive data from and transmit data to the local network via the gateway; and
a secondary shipment controller configured to communicate with the local network and to communicate with the central shipment controller, the secondary shipment controller operable to generate and transmit a receipt to the central shipment controller upon arrival of one of the assets at a destination;
wherein each identification device has a plurality of operating states, and includes a local device controller operable to switch the identification device between device operating states.

2. The system of claim 1, wherein each identification device includes stored data including data required to enable accountable record transactions.

3. The system of claim 2, wherein the stored data includes a destination code and a priority code generated by the central shipment controller.

4. The system of claim 1, wherein each identification device has an associated status code that includes information selected from a group consisting of transit status information, alert indicators, and movement flags.

5. The system of claim 4, wherein the local device controller is operable to generate the status code.

6. The system of claim 4, wherein the local device controller is operable to switch the identification device between device operating states having different network polling rates based at least in part on the status code.

7. The system of claim 1, wherein the local network includes an environmental condition sensor and wherein the identification devices are operable to store environmental data received from the environmental condition sensor.

8. The system of claim 1, further comprising a global positioning system unit in communication with the gateway.

9. The system of claim 1, wherein the gateway is a mobile gateway with a first communication unit and a satellite communication unit, the mobile gateway configured to communicate with the central shipment controller using the first communication unit when infrastructure for the first communication unit is available and to communicate with the central shipment controller using the satellite communication unit when the infrastructure for the first communication unit is not available.

10. The system of claim 9, wherein the first communication unit comprises a cellular communication unit.

11. The system of claim 9, wherein the first communication unit is configured to connect to the Internet.

12. A munitions transfer method comprising:
self forming a first local network from a plurality of identification devices, each identification device associated with an asset, the identification devices operable to initiate communication with other identification devices to form the local network and are further operable to poll other identification devices to determine which identification devices are present in the network, each identification device in wireless communication with at least one other identification device such that each identification device is capable of direct or indirect communication with other identification devices in the network;
communicating availability of assets associated with the plurality of identification devices forming the local network to a central shipment controller via a gateway in communication with the local network;
using the central shipment controller to generate a shipment order in response to an ammunition request, the shipment order including destination and priority codes for ordered assets associated with a first subset of devices of the plurality of identification devices;
communicating the destination and priority codes from the central shipment controller to the first subset of devices; and
using a secondary shipment controller to generate a receipt upon arrival of the ordered assets.

13. The method of claim 12, further comprising using one of the central shipment controller or the secondary shipment controller to revise one of the destination code in response to receipt of a higher priority ammunition request.

14. The method of claim 12, further comprising setting a device status code and storing the device status code in memory included in an associated identification device, the status code including at least one of a transit status flag, an environmental condition flag, a movement flag, and a power status flag.

15. The method of claim 14, further comprising switching the identification device between device operating states having different network polling rates based at least in part on the status code.

16. The method of claim 12, further comprising monitoring an environmental condition sensor included on one of the identification devices.

17. The method of claim 12, further comprising establishing communications between the gateway and one of the central and secondary shipment controllers using a first communication unit when infrastructure for the first communication unit is available and using a satellite communication unit when the infrastructure for the first communication unit is not available.

18. The method of claim 12, further comprising using a parent identification device to conduct a local network poll to determine which identification devices are present in the network.

19. The method of claim 18, further comprising using the parent identification device to reform the local network if the identification devices present changed from a previous network poll.

20. The method of claim 18, further comprising communicating to the gateway a listing of identification devices present at the previous network poll that did not respond to the current network poll.

21. An asset inventory tracking system comprising:
a local network formed of a plurality of identification devices, each identification device associated with an asset, the identification devices operable to initiate communication with other identification devices to form the local network and are further operable to poll other identification devices to determine which identification devices are present in the network, each identification device in wireless communication with at least one other identification device such that each identification device is capable of direct or indirect communication with other identification devices in the network;
a gateway in wireless communication with the local network via at least one of the plurality of identification devices to allow direct or indirect communication between the gateway and each identification device in the local network; and
a central shipment controller configured to communicate with the gateway, the central shipment controller operable to receive data from and transmit data to the local network via the gateway;
wherein each identification device has a plurality of operating states and includes a local device controller operable to switch the identification device between device operating states.

22. The system of claim 21, wherein each identification device has an associated data set to accomplish transactions.

23. The system of claim 22, wherein the data sets are generated by the central shipment controller.

24. The system of claim 22, further comprising a secondary shipment controller configured to communicate with the gateway and to communicate with the central shipment controller.

25. The system of claim 21, wherein the local device controller is operable to switch the identification device between device operating states having different network polling rates based at least in part on a device status code that includes at least one of a transit status flag, an environmental condition flag, a movement flag, and a power status flag.

26. The system of claim 21, wherein the local network includes an environmental condition sensor and the identification devices are operable to store environmental condition data.

27. The system of claim 21, wherein the gateway is a mobile gateway with a first communication unit and a satellite communication unit, the mobile gateway configured to communicate with the central shipment controller using the first communication unit when infrastructure for the first communication unit is available and to communicate with the central shipment controller using the satellite communication unit when the infrastructure for the first communication unit is not available.

28. An identification tag comprising:
a power supply;
wireless communications circuitry powered by the power supply; and
a controller powered by the power supply, the controller configured to operate the communications circuitry to communicate with a second identification tag and further configured to switch the identification tag from a first operating state to a second operating state.

29. The identification tag of claim 28, wherein the controller is configured to operate the communications circuitry to receive data specific to a plurality of other identification tags, to generate a combined data signal based on data specific to the identification tag with the data specific to the plurality of other identification tags, and to transmit the combined data signal.

30. The identification tag of claim 29, wherein the controller is configured to select a third identification tag and to transmit the combined data signal information to the third identification tag.

31. The identification tag of claim 30, wherein the controller is configured to select the third identification tag based at least in part on a low power signal transmitted by another identification tag.

32. The identification tag of claim 28, further comprising an environmental sensor and the controller is configured to generate a status code based on readings of the environmental sensor.

33. The identification tag of claim 28, wherein the controller is configured to check for the presence of a network of linked identification tags upon activation of the identification tag.

34. The identification tag of claim 28, wherein the first operating state has a first network polling rate and the second operating state has a second network polling rate and the controller is configured to switch the identification tag between the first operating state and the second operating state based at least in part on a status code including at least one of a transit status flag, an environmental condition flag, a movement flag, and a power status flag.

35. The identification tag of claim 28, wherein the controller is configured to operate the wireless communications circuitry when the identification tag is in the first operating state and an alternate communications device when the identification tag is in the second operating state.

36. The identification tag of claim 28, wherein the identification tag is configured to use less power in the first operating state than in the second operating state.

37. The identification tag of claim 36, wherein the controller is configured to switch the identification tag from the first operating state to the second operating state in response to a signal from a motion detector.

38. The identification tag of claim 28, wherein the controller is configured to generate a request to join a detected network of identification tags when the identification tag is in the first operating state.

39. The identification tag of claim 38, wherein the controller is configured to form a new network when the identification tag is in the second operating state.
